(19) United States
(12) Patent Application Publication
(10) Pub. No.: US 2025/0338264 A1
(43) Pub. Date: Oct. 30, 2025

(54) DYNAMIC SUB-BAND OPERATION UNDER COEXISTENCE CONSTRAINT

(71) Applicant: Samsung Electronics Co., Ltd., Suwon-si (KR)

(72) Inventors: Peshal Nayak, Plano, TX (US); Vishnu Vardhan Ratnam, Plano, TX (US); Bilal Sadiq, Plano, TX (US); Rubayet Shafin, Frisco, TX (US); Boon Loong Ng, Plano, TX (US); Yue Qi, Plano, TX (US)

(21) Appl. No.: 19/178,742

(22) Filed: Apr. 14, 2025

Related U.S. Application Data
(60) Provisional application No. 63/639,344, filed on Apr. 26, 2024.
(60) Provisional application No. 63/639,354, filed on Apr. 26, 2024.

(51) Int. Cl. H04W 72/0453

(52) U.S. Cl. CPC H04W 72/0453

(57) ABSTRACT

A method and device for dynamic sub-band operation under coexistence constraint/unavailability. A method performed by a station (STA) associated with an access point (AP) comprises indicating, to the AP, that the STA faces an unavailability; negotiating, with the AP, for a frequency on which the STA can receive a transmission from the AP that avoids the unavailability; and receiving, from the AP, the transmission that avoids the unavailability on the frequency.

### CROSS-REFERENCE TO RELATED APPLICATIONS AND CLAIM OF PRIORITY

This application claims priority under 35 U.S.C. § 119(e) to U.S. Provisional Patent Application No. 63/639,344, filed on Apr. 26, 2024, and U.S. Provisional Patent Application No. 63/639,354, filed on Apr. 26, 2024, which are hereby incorporated by reference in their entirety.

### TECHNICAL FIELD

This disclosure relates generally to wireless communication, and more specifically to dynamic sub-band operation under coexistence constraint/unavailability.

### BACKGROUND

Wireless Local Area Network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple input Multiple Output (MIMO) technology represents one such approach that has emerged as a popular technique. MIMO has been adopted in several wireless communications qandards such 802.11ac, 802.11ax, etc.

### SUMMARY

Embodiments of the present disclosure provide methods and apparatuses for dynamic sub-band operation under coexistence constraint/unavailability.

In one embodiment, a method performed by a station (STA) associated with an access point (AP) comprises indicating, to the AP, that the STA faces an unavailability. The method includes negotiating, with the AP, for a frequency on which the STA can receive a transmission from the AP that avoids the unavailability. The method further includes receiving, from the AP, the transmission that avoids the unavailability on the frequency.

In another embodiment, an AP comprises a transceiver; and a processor operably coupled with the transceiver. The processor is configured to: receive, via the transceiver, an indication from a STA associated with the AP that the STA faces an unavailability; and negotiate, with the STA, for a frequency on which the STA can receive a transmission from the AP that avoids the unavailability. The transceiver is configured to transmit information to the STA on the frequency that avoids the unavailability.

In yet another embodiment, a STA comprises a transceiver; and a processor operably coupled with the transceiver. The processor is configured to: transmit, via the transceiver, an indication to an AP associated with the STA that the STA faces an unavailability; negotiate, with the AP, for a frequency on which the STA can receive a transmission from the AP that avoids the unavailability; and transmit, via the transceiver, information to the AP on the frequency that avoids the unavailability.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example AP according to embodiments of the present disclosure;

FIG. 3 illustrates an example STA according to embodiments of the present disclosure;

FIG. 4 illustrates an example of a ranging round according to embodiments of the present disclosure;

FIG. 5 illustrates an example of a beacon interval, active and passive phases for ZigBee according to embodiments of the present disclosure;

FIG. 6 illustrates an example of basic service set (BSS) bandwidth wastage due to narrow band operation according to embodiments of the present disclosure;

FIG. 7 illustrates an example operation of dynamic sub-band operation (DSO) according to embodiments of the present disclosure;

FIG. 8 illustrates an example that depicts the problem due to coexistence/unavailability in DSO operation according to embodiments of the present disclosure;

FIG. 9 illustrates an example that depicts an alternative allocation of frequency blocks according to embodiments of the present disclosure;

FIG. 10 illustrates an example of a method for co-ex/unavailability mode indication according to embodiments of the present disclosure;

FIG. 11 illustrates an example of a negotiation phase for dynamic sub-band operation (DSO) according to embodiments of the present disclosure;

FIG. 12 illustrates a negotiation phase procedure according to embodiments of the present disclosure;

FIG. 13 illustrates an example negotiation procedure 1200 according to embodiments of the present disclosure;

FIG. 14 illustrates an example DSO operation according to embodiments of the present disclosure;

FIG. 15 illustrates another example DSO operation according to embodiments of the present disclosure;

FIG. 16 illustrates an example that depicts wastage of frequency resources due to channel utilization according to embodiments of the present disclosure;

FIG. 17 illustrates an example operation for non-primary channel access during a co-ex event/unavailability according to embodiments of the present disclosure;

FIG. 18 illustrates an example operation for non-primary channel access based on deferred signal transmission on the primary channel according to embodiments of the present disclosure;

FIG. 19 illustrates an example operation for non-primary channel access by leaving the primary channel idle according to embodiments of the present disclosure; and

FIG. 20 illustrates an example method performed by a STA in a wireless communication system according to embodiments of the present disclosure.

### DETAILED DESCRIPTION

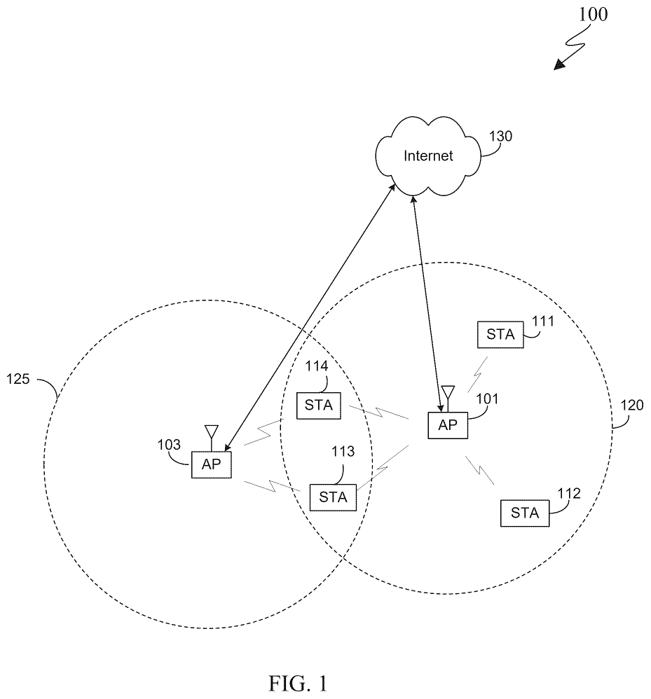

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D2.0, 2022; [2] IEEE Std 802.11-2020.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP”, such as “router” or “gateway”. For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA”, such as “mobile station”, “subscriber station”, “remote terminal”, “user equipment”, “wireless terminal”, or “user device”. For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating dynamic sub-band operation under coexistence constraint/unavailability. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

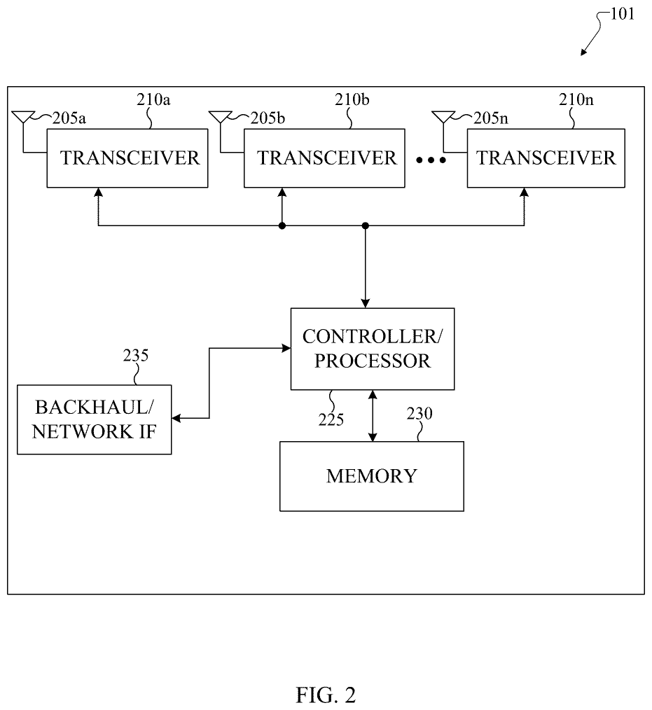

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating dynamic sub-band operation under coexistence constraint/unavailability. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating dynamic sub-band operation under coexistence constraint/unavailability. Although FIG. 2 illustrates one example of AP 101, various changes may be made to FIG. 2. For example, the AP 101 could include any number of each component shown in FIG. 2. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2 could be combined, further subdivided, or omitted and additional components could be added according to particular needs.

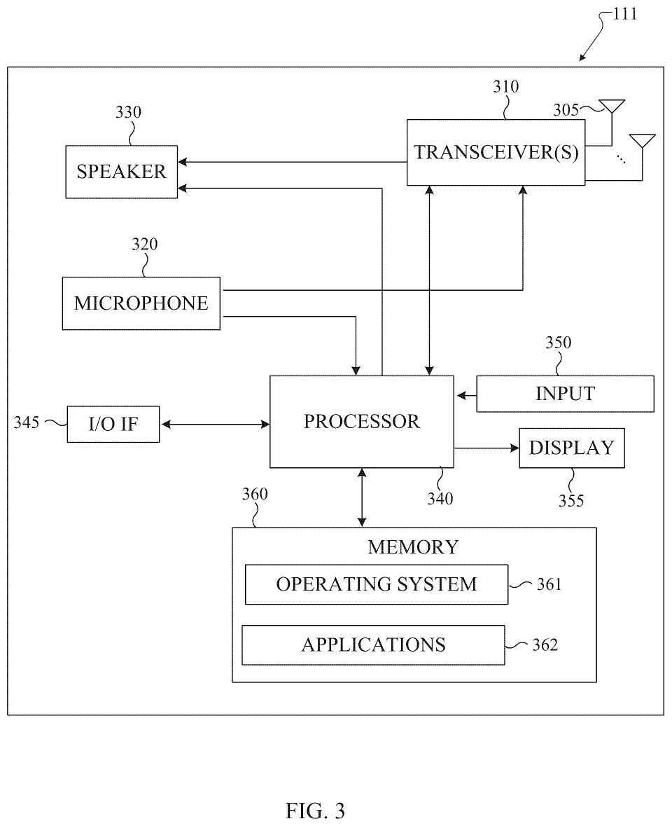

FIG. 3 illustrates an example STA 111 according to various embodiments of the present disclosure. The embodiment of the STA 111 illustrated in FIG. 3 is for illustration only, and the STAs 111-115 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate dynamic sub-band operation under coexistence constraint/unavailability. In some embodiments, the processor 340 includes at least one microprocessor or microcontroller.

The processor 340 is also capable of executing other processes and programs resident in the memory 360, such as operations for facilitating dynamic sub-band operation under coexistence constraint/unavailability. The processor 340 can move data into or out of the memory 360 as required by an executing process. In some embodiments, the processor 340 is configured to execute a plurality of applications 362, such as applications for facilitating. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

Embodiments of the present disclosure recognize that Wi-Fi devices can have a number of Wi-Fi and non-Wi-Fi radios that can co-exist on the same device. Some non-Wi-Fi technology radios which can co-exist with Wi-Fi are as stated blow:

Bluetooth is a wireless technology that started off as a short-distance cable replacement mechanism. Bluetooth classic which is used for streaming applications (e.g., headset) operates on 79 RF channels each spaced 1 MHz apart. Bluetooth low energy (BLE) on the other hand which is used for IoT applications operates on 40 RF channels each spaced 2 MHz apart. In the case of Bluetooth, some channels are reserved specifically for the purpose of advertisement and others are used for secondary advertisement for data transmission. In the case of Bluetooth classic, 32 channels are reserved for advertisement whereas in the case of BLE 3 channels are reserved for advertisement.

In Bluetooth transmission happens as a part of a connection event. During a connection event, two devices that are engaged in data transmission alternate sending data until the data to be sent on both sides is exhausted. One of the device acts as the master and the other device acts as the slave. The master sends a packet to the slave and if the slave receives the packet it sends back a packet to the master. The duration between two connection events is called a connection interval. Connection interval values can range from 7.5 ms to 4 s. The exact value can be negotiated between the master and the slave to optimize their power saving while balancing latency incurred. Bluetooth transmissions follow frequency hopping spread spectrum method where a hopping sequence is used to rapidly hop between data channels.

As Bluetooth and Wi-Fi follow different channel access protocols, coexistence of Bluetooth can lead to interference to Wi-Fi transmission. Some Bluetooth transmissions can be scheduled making the interference more predictable. However, in other cases, Bluetooth interference can be hard to predict in advance. Thus, Wi-Fi needs to have mechanisms to react to Bluetooth interference when it occurs in such cases.

Today Bluetooth is used for a large number of applications such as streaming applications, sensor applications, way finding based on beaconing, etc. Wi-Fi routers from a few vendors also come equipped with Bluetooth radios for the purpose of way finding/location awareness applications. Further, an end user's phone can also be configured as a Mobile AP which can also have Bluetooth operating on it.

Bluetooth has primarily operated on the 2.4 GHz band. However, in next generation Bluetooth technology, the operation is expected to be extended to 5 GHz and 6 GHz band as well. Thus, the interference problem can be worse for Wi-Fi operation which also uses these bands for communication.

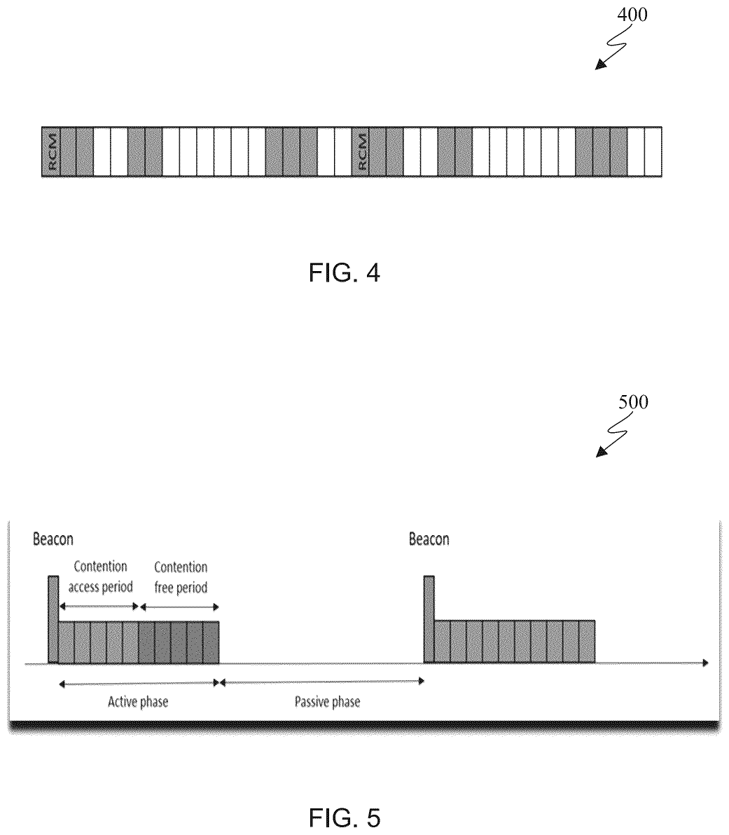

FIG. 4 illustrates an example 400 of a ranging round according to embodiments of the present disclosure. The embodiment of the example 400 of a ranging round shown in FIG. 4 is for illustration only. Other embodiments of the example 400 of a ranging round could be used without departing from the scope of this disclosure.

Ultra-Wide Band (UWB) has recently become popular for use cases involving indoor positioning and navigation using the 6 GHz band. The 802.15.4 amendment defines a block based mode for ranging in which there are ranging blocks which are divided into ranging rounds which are further divided into ranging slots. The number of ranging rounds in a ranging block, the number of ranging slots in a ranging round and the duration of ranging slot are transmitted by the controller in ranging control message (RCM) to the participant devices. The information can be for current ranging round and potential subsequent ranging rounds as well. A ranging slot in which the device is expected to be active is referred to as active slots. There can also be inactive and silent periods. An example ranging round is as shown in FIG. 4.

FIG. 5 illustrates an example 500 of a beacon interval, active and passive phases for ZigBee according to embodiments of the present disclosure. The embodiment of the example 500 of a beacon interval, active and passive phases for ZigBee shown in FIG. 5 is for illustration only. Other embodiments of the example 500 of a beacon interval, active and passive phases for ZigBee could be used without departing from the scope of this disclosure.

ZigBee protocol is another technology developed for smart home applications. The protocol operates based on the concept of beacon intervals. The coordinator in a ZigBee operation sends out periodic beacons. Each beacon is followed by the start of an active phase. The beacon announced the duration of the active phase and the time until the next beacon transmission. Each beacon interval thus is divided into two phases—1. Active phase which starts right after the beacon 2. Passive phase for power save. The active phase can be divided into a contention based period and a contention free period. The duration of each of the phases and the beacon interval can be characterized by aBaseSlotDuration value, macBeaconOrder (BO) and macSuperframeOrder (SO). BO and SO are integer values ranging from 0 to 14. The beacon interval can be computed as aBaseSuperframeDuration*2^{BO} and the active phase can be computed as aBaseSuperframeDuration*2^{SO} where aBaseSuperframeDuration=16*aBaseSlotDuration. An example timeline is as shown in FIG. 5.

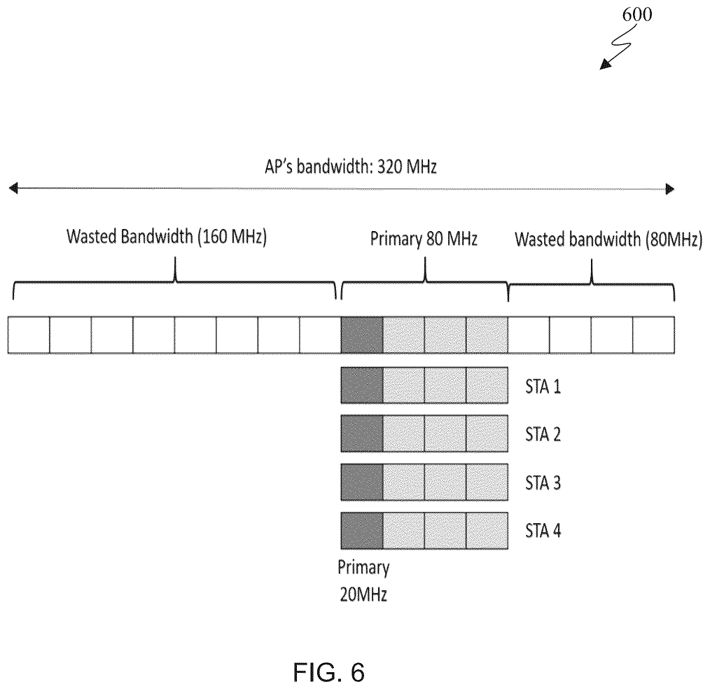

FIG. 6 illustrates an example 600 of BSS bandwidth wastage due to narrow band operation according to embodiments of the present disclosure. The embodiment of the example 600 of BSS bandwidth wastage due to narrow band operation shown in FIG. 6 is for illustration only. Other embodiments of the example 600 of BSS bandwidth wastage due to narrow band operation could be used without departing from the scope of this disclosure.

Due to an increasing demand for high throughput support, the maximum bandwidth that can be support has continued to grow in each generation of Wi-Fi networks. In IEEE 802.11be, a BSS can support up to 320 MHz bandwidth of operation. The expectation is that an increasing bandwidth can satisfy the demand for higher throughput. However, this increasing bandwidth can also result in frequency wastage if not utilized efficiently. If the non-AP STAs support wide band operation, it can be possible to utilize the entire 320 MHz for transmission/reception. Unfortunately, due to cost and power constraints, non-AP STAs typically operate on narrow bandwidth. Further, even in the case of non-AP STAs that support wide bandwidth operation, a portion of the bandwidth can be busy due to non-BSS devices. This can result in a narrow band operation even if the AP supports a wide band operation. Thus, a portion of the frequency resources of a BSS can get wasted. An example can be as shown in FIG. 6.

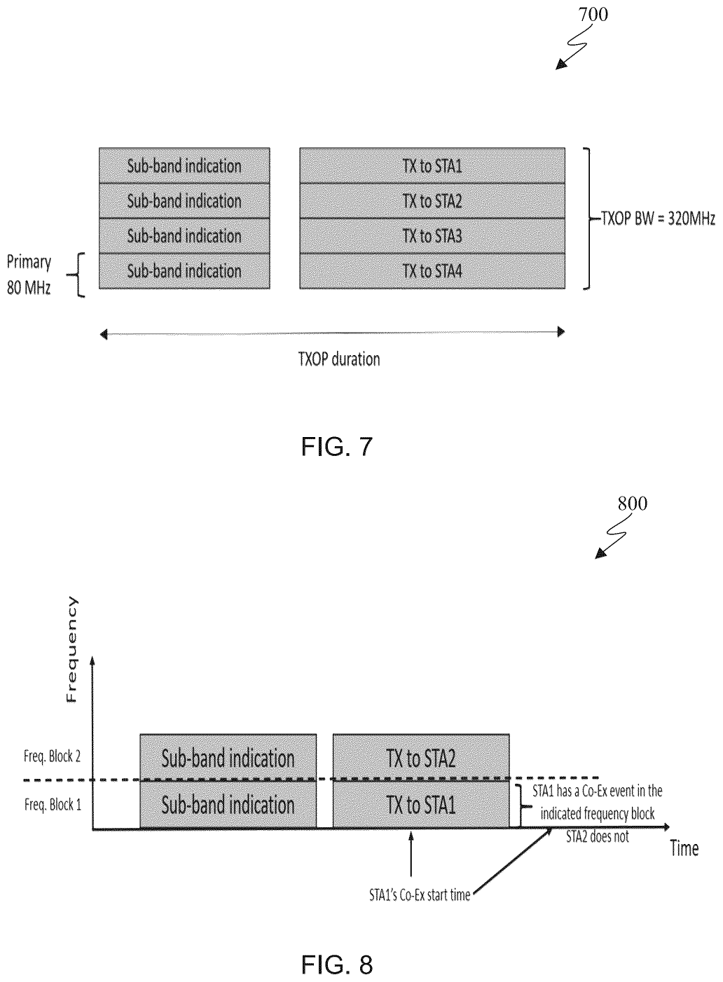

FIG. 7 illustrates an example operation 700 of DSO according to embodiments of the present disclosure. The embodiment of the example operation 700 of DSO shown in FIG. 7 is for illustration only. Other embodiments of the example operation 700 of DSO operation could be used without departing from the scope of this disclosure.

To allow for full bandwidth utilization when an AP with a wide band support operates with non-AP STAs with narrow band support, dynamic sub-band operation (DSO) has been proposed in 802.11bn. A DSO device is a limited bandwidth device, that can switch to a specific sub-band of the AP's operating channel on demand. Thus, when winning a TXOP for 320 MHz, an AP can indicate different DSO capable STAs to switch to different 80 MHz sub-bands that jointly occupy the entire 320 MHz in a sub-band switch initial control (SBS IC) frame. The AP initiates transmission to the DSO STAs on their specified sub-bands after sufficient delay to allow the DSO devices to perform the channel switch. The AP also ensures protection of the TXOP for the duration of this switch. At the end of the TXOP the DSO STAs switch back to the primary channel. An illustration of the DSO operation is provided in FIG. 7.

FIG. 8 illustrates an example 800 that depicts the problem due to coexistence/unavailability in DSO operation according to embodiments of the present disclosure. The embodiment of the example 800 that depicts the problem due to coexistence/unavailability in DSO operation shown in FIG. 8 is for illustration only. Other embodiments of the example 800 that depicts the problem due to coexistence/unavailability in DSO operation could be used without departing from the scope of this disclosure.

When an AP provides an indication of the sub-band on which it can transmit to a non-AP STA in DSO operation, the non-AP STA may not be available on that sub-band. For instance, the non-AP STA can have a Co-Ex event due to its Bluetooth radio. This can result in frequency wastage as the transmission from the AP to the STA on the indicated sub-band can fail. However, due to the wide bandwidth of operation, it can still be possible for the same STA to receive the transmission from the AP on a different portion of the bandwidth and avoid an impact from the Co-Ex event. An illustration can be as shown in FIG. 8.

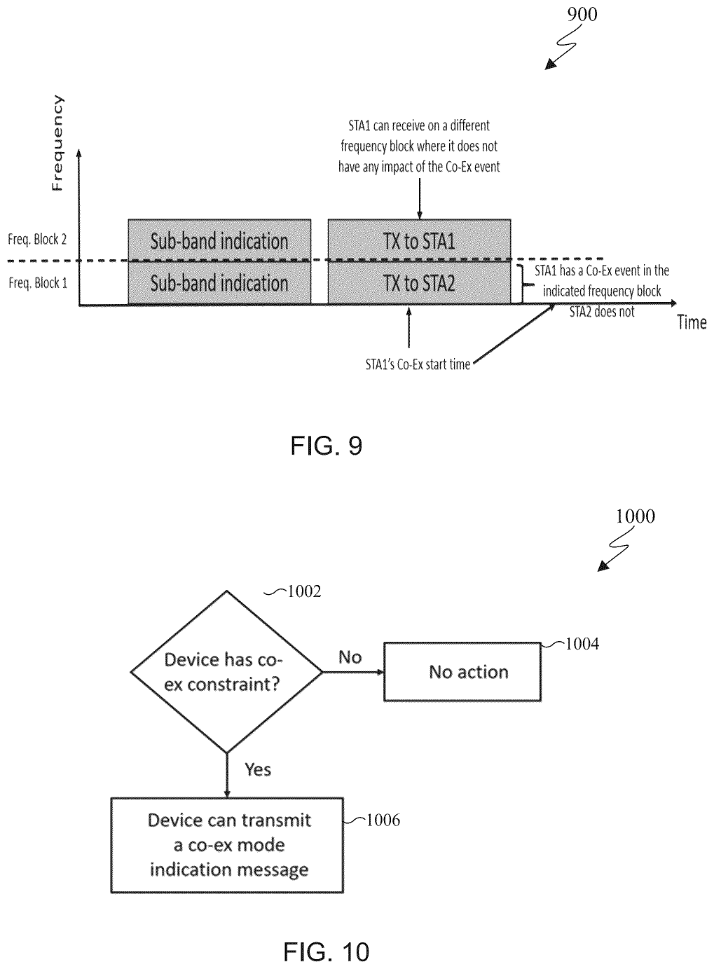

FIG. 9 illustrates an example 900 that depicts an alternative allocation of frequency blocks according to embodiments of the present disclosure. The embodiment of the example 900 that depicts an alternative allocation of frequency blocks shown in FIG. 9 is for illustration only.

Other embodiments of the example 900 that depicts an alternative allocation of frequency blocks could be used without departing from the scope of this disclosure.

As illustrated in FIG. 9, STA 1 has a co-ex event/unavailability in the indicated frequency block, whereas STA 2 does not. In some embodiments, STA 1 can receive on a different frequency block where it does not have any impact on the co-ex event/unavailability.

Primary and non-primary channel: Under the current wideband channel usage in Wi-Fi, channels are divided into primary and secondary channels. For 802.11 transmission to occur on a wideband, the primary channel must be idle. If the primary channels are busy, the secondary channels cannot be accessed.

When a co-existence event/unavailability occurs on the primary channel, the wide/narrow band transmission between the AP and the STA can fail resulting in resource wastage. This can be as depicted in FIG. 16.

Embodiments of the present disclosure recognize that procedures to enable the behavior described above with respect to FIG. 9 are needed for coexistence constraint/unavailability handling under DSO operation. Further, embodiments of the present disclosure recognize that when a co-existence event/unavailability occurs on the primary channel, the wide/narrow band transmission between the AP and the STA can fail resulting in resource wastage.

Accordingly, embodiments of the present disclosure provide mechanisms for a co-ex mode indication procedure for coexistence constraint/unavailability handling under DSO operation. Further, embodiments of the present disclosure provide mechanisms for a negotiation procedure for coexistence constraint/unavailability handling under DSO operation. In addition, embodiments of the present disclosure provide mechanisms for: a secondary channel indication; an unavailability indication; and operation during co-ex event for handling non-primary channel access under coexistence constraints/unavailability.

FIG. 10 illustrates an example of a method 1000 for co-ex/unavailability mode indication according to embodiments of the present disclosure. The embodiment of the example method 1000 for co-ex/unavailability mode indication shown in FIG. 10 is for illustration only. Other embodiments of the method 1000 for co-ex/unavailability mode indication could be used without departing from the scope of this disclosure.

According to some embodiments, a device can transmit a co-ex/unavailability mode indication message to the AP. Based on the co-ex/unavailability mode indication, the AP can know that the device has a co-ex constraint.

For example, as illustrated in FIG. 10, the method 1000 begins at step 1002, where a determination is made whether the device has a co-ex constraint or unavailability. If not, then at step 1004, no action is taken. If yes, then at step 1006, the device can transmit a co-ex/unavailability mode indication message to the AP.

The co-ex/unavailability mode indication message can contain at least one or more of the information items as indicated in Table 1.

TABLE 1
Co-ex mode indication message content

| Information | |
|---|---|
| item | Description |
| Co-ex mode | An indication that the device has a co-ex constraint. |
| indicator | E.g., a bit, flag, etc. |
| Start time | An indication of the start time(s) of the co-ex event. |
| | E.g., start time of co-ex with an indication of its |
| | periodicity. |
| Duration | An indication of the duration for which the co-ex event |
| | can last. E.g., value in microseconds |
| Interval | An indication of the interval of the co-ex event. E.g., |
| | the time period between two start times. |
| Aperiodicity | An indication that the co-ex event is not periodic. |
| indication | E.g., can be predicted closer to the co-ex event but not |
| | known in advance. |

The co-ex/unavailability indication message can create an awareness on the AP side about the co-ex constraint of the device. With this knowledge the AP can trigger any of the procedures described herein to handle the co-ex constraint of the non-AP STA.

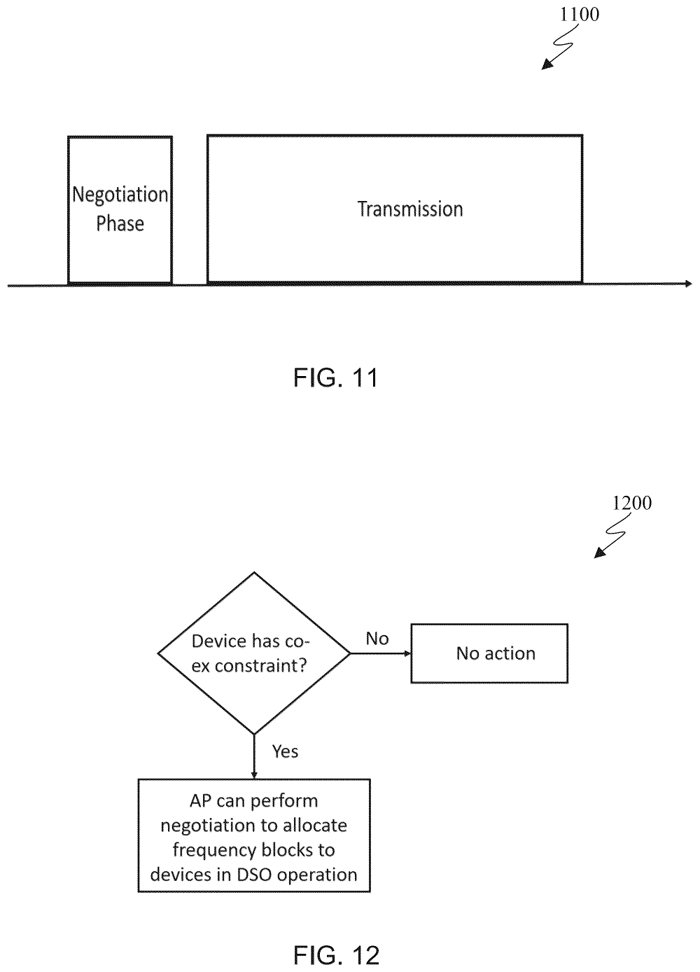

FIG. 11 illustrates an example 1100 of a negotiation phase for DSO according to embodiments of the present disclosure. The embodiment of the example 1100 of a negotiation phase for DSO shown in FIG. 11 is for illustration only. Other embodiments of the example 1100 of a negotiation phase for DSO could be used without departing from the scope of this disclosure.

According to some embodiments, there can be a negotiation phase prior to the transmission phase (step 1006 of FIG. 10) as shown in FIG. 11. The negotiation phase can involve determining which frequency block the non-AP STA can face a co-ex/unavailability event on. This can enable the AP to assign the frequency blocks to the non-AP STAs for DSO operation.

FIG. 12 illustrates a negotiation phase procedure 1200 according to embodiments of the present disclosure. The embodiment of the negotiation phase procedure 1200 shown in FIG. 12 is for illustration only. Other embodiments of the negotiation phase procedure 1200 could be used without departing from the scope of this disclosure.

As illustrated in FIG. 12, if the device has a co-ex constraint or unavailability, the AP can perform negotiation to allocate frequency blocks to devices in DSO operation.

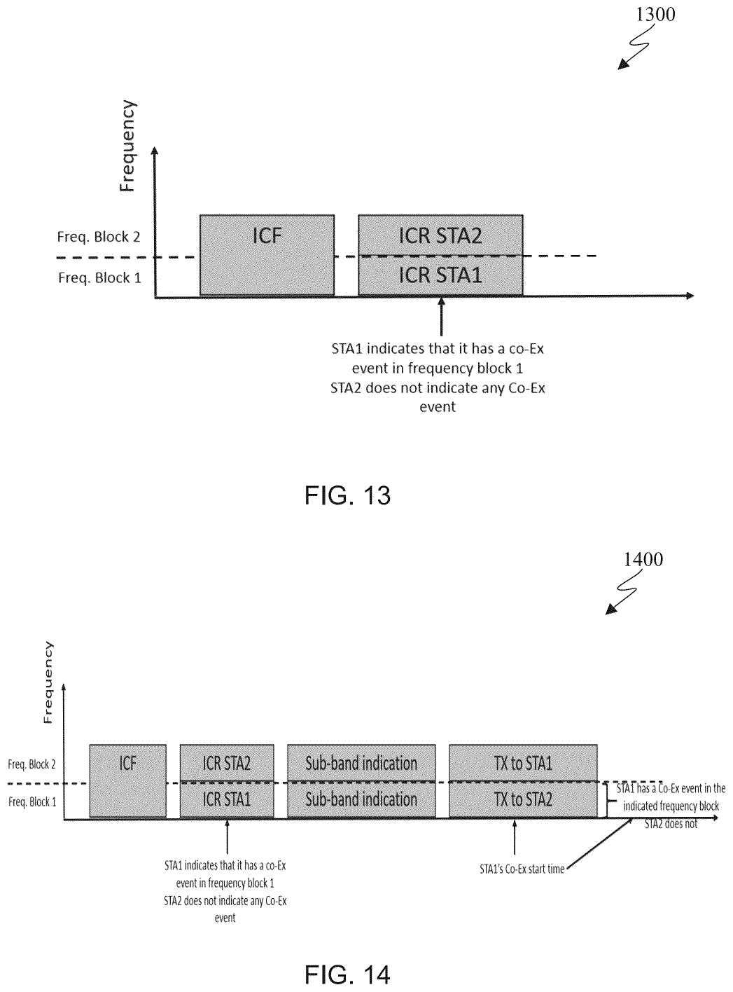

FIG. 13 illustrates an example negotiation procedure 1300 according to embodiments of the present disclosure. The embodiment of the example negotiation procedure 1300 shown in FIG. 13 is for illustration only. Other embodiments of the example negotiation procedure 1300 could be used without departing from the scope of this disclosure.

As illustrated in FIG. 13, there can be an initial control message (e.g., an initial control frame (ICF)) which can contain at least one or more of the information items as indicated in Table 2. For example, the ICF may contain information that can describe the frequency blocks that can be used for DSO operation, and/or information that provides an example allocation of the DSO frequency blocks to the target STAs.

TABLE 2
Information items that can be present in the ICF

| Information | |
|---|---|
| item | Description |
| Frequency | An information item that can describe the frequency blocks |
| blocks | that can be used for DSO operation. E.g., the channels that |
| | will be allocated for DSO. |
| Example | An information item that provide an example allocation of |
| allocation | the DSO frequency blocks to the target STAs. |

Upon receiving the initial control message, the non-AP STAs can respond with a response message, such as an information control response (e.g., ICR). The response message can contain at least one or more of the information items as indicated in Table 3.

TABLE 3
Information items that can be present in the ICR

| Information | |
|---|---|
| item | Description |
| Frequency | An information item that can describe the frequency |
| blocks | blocks where the non-AP STA is either not facing co-ex |
| | event or is facing co-ex event. E.g., via a channel bitmap. |
| Start time | An information item that can describe the start time of |
| | the co-ex event. |
| Duration | An information item that can describe the duration of |
| | the co-ex event. |
| Interference | An information item that can describe the interference |
| level | event from the co-ex event. |
| Transmit | An information item that can describe the transmit |
| parameters | parameters such as robust data rates, payload adaptation, |
| | etc. that the transmitter can use to transmit to the device. |
| | The transmitter can also use the same frequency block and |
| | use a post-FCS padding that starts before the co-ex event |
| | starting point. |

Based on the ICR message, the transmitter can then adapt the transmission message and perform a DSO operation.

FIG. 14 illustrates an example DSO operation 1400 according to embodiments of the present disclosure. The embodiment of the example DSO operation 1400 shown in FIG. 14 is for illustration only. Other embodiments of the example DSO operation 1400 could be used without departing from the scope of this disclosure.

As illustrated in FIG. 14, the ICR can contain information items that can describe the frequency blocks where the non-AP STA is either not facing a co-ex event/unavailability or is facing a co-ex event/unavailability. The ICR may also contain information that can describe the start time of the co-ex event/unavailability, a duration of the co-ex event/unavailability, and/or the interference level.

For example, STA 1 may indicate that it has a co-ex event/unavailability in frequency block 1, and STA 2 may indicate that it does not have any co-ex event/unavailability. Further, STA 1 may indicate that it has a co-ex event/unavailability in the indicated frequency block and the start time of the co-ex event/unavailability, and STA 2 may indicate that it does not have any co-ex event/unavailability in the indicated frequency block. In that case, STA 2's sub-band may be allocated to STA 1 and STA 1's sub-band may be allocated to STA 2 so that transmission to STA 1 can occur in the indicated frequency block.

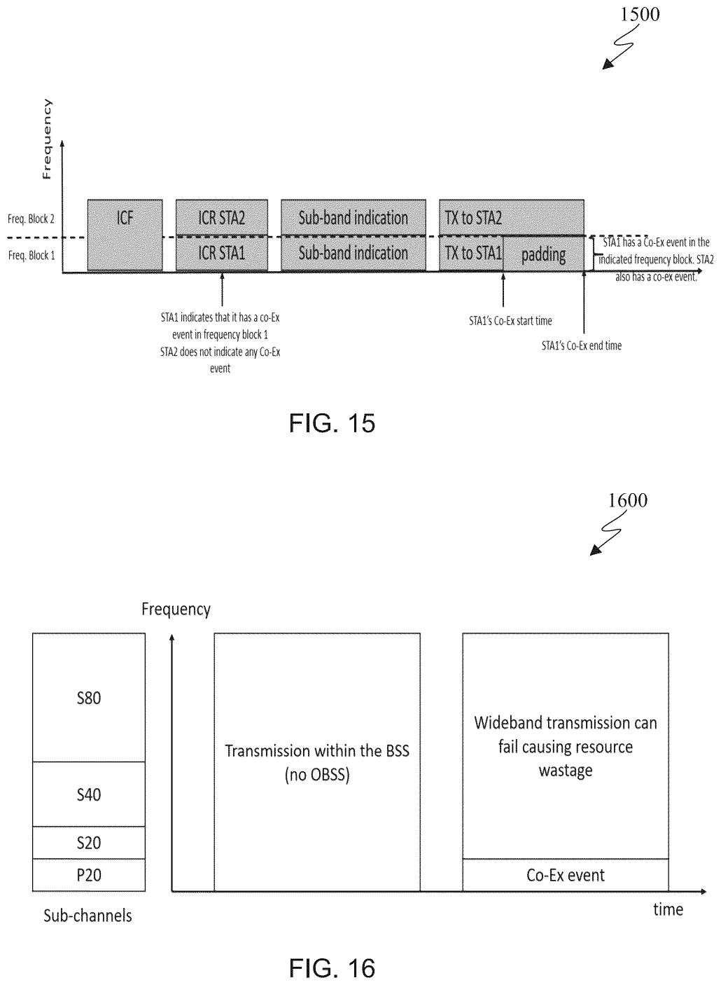

FIG. 15 illustrates another example DSO operation 1500 according to embodiments of the present disclosure. The embodiment of the example DSO operation 1500 shown in FIG. 15 is for illustration only. Other embodiments of the example DSO operation 1500 could be used without departing from the scope of this disclosure.

As illustrated in FIG. 15, STA 1 may indicate that it has a co-ex event/unavailability in frequency block 1, and STA 2 may indicate that it does not have any co-ex event/unavailability. Further, STA 1 may indicate that it has a co-ex event/unavailability in the indicated frequency block and the start and end times of the co-ex event/unavailability, and STA 2 may indicate that it also has a co-ex event/unavailability in the indicated frequency block. In that case, the transmitter can use the same frequency block and use a padding parameter that starts before the co-ex event/unavailability starting point.

FIG. 16 illustrates an example 1600 that depicts wastage of frequency resources due to channel utilization according to embodiments of the present disclosure. The embodiment of the example 1600 that depicts wastage of frequency resources due to channel utilization shown in FIG. 16 is for illustration only. Other embodiments of the example 1600 that depicts wastage of frequency resources due to channel utilization could be used without departing from the scope of this disclosure.

When a co-ex even/unavailability occurs on the primary channel, the wide/narrow band transmission between the AP and the STA can fail resulting in resource wastage. This can be as depicted in FIG. 16.

According to some embodiments, the AP and the STA can negotiate a secondary channel to which they can switch and perform transmission, if the reception on the primary channel can face co-ex based interference/unavailability.

The negotiation can comprise a negotiation request message which can contain at least one or more of the information items as indicated in Table 4.

TABLE 4
Negotiation request message

| Information | |
|---|---|
| item | Description |
| Primary | An information item that can describe the primary channel |
| channel(s) | that can face co-ex interference/unavailability. |
| indication | |
| Non-primary | An information item that can describe the non-primary |
| channel(s) | channel where the transmission can occur if the primary |
| indication | channel reception is expected to face a co-ex |
| | interference/unavailability. |

The negotiation request message can be responded to with a negotiation response message. The negotiation response message can contain at least one or more of the information items as indicated in Table 5.

TABLE 5
Negotiation response message

| Information | |
|---|---|
| item | Description |
| Non-primary | An information item that can describe the non-primary |
| channel(s) | channel where the transmission can occur if the primary |
| indication | channel reception is expected to face a co-ex |
| | interference/unavailability. This can be a confirmation |
| | and can be the same channels as requested or different |
| | channels. |

Whenever the AP switches to the non-primary channel due to a co-ex event/unavailability issue at the intended STA, the AP can transmit an unavailability message to the other STA(s) to indicate that the AP can be unavailable during the time. The unavailability message can be a defer signal which can cause the STA(s) to go into a deferral state or error recovery state (e.g., EIFS state). This can prevent any STA in the BSS from capturing the channel and making a transmission to the AP when the AP is unavailable.

When the co-existence event occurs, the STA can make an indication in the initial control response (ICR) message that it transmits to the AP. The AP and the STA can then jump to the non-primary channel and make the transmission. The non-primary channel can either be negotiated beforehand or can be recommended by the AP/STA.

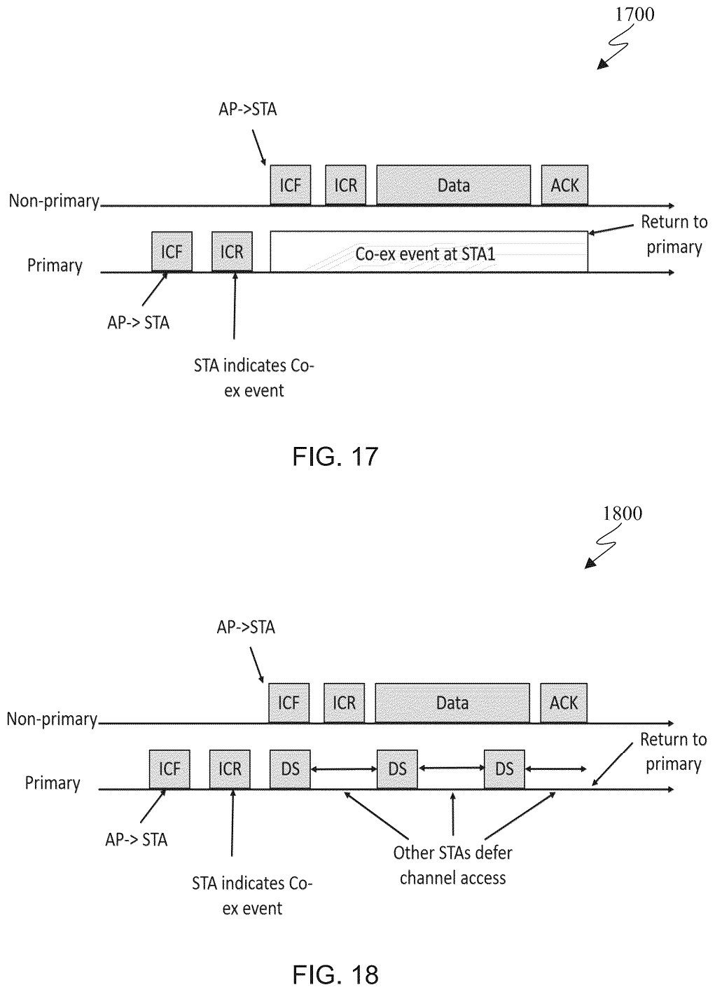

FIG. 17 illustrates an example operation 1700 for non-primary channel access during a co-ex event/unavailability according to embodiments of the present disclosure. The embodiment of the example operation 1700 for non-primary channel access during a co-ex event/unavailability shown in FIG. 17 is for illustration only. Other embodiments of the example operation 1700 for non-primary channel access during a co-ex event/unavailability could be used without departing from the scope of this disclosure.

As illustrated in FIG. 17, the AP and the STA can jump to the non-primary channel and make the transmission during a co-ex event/unavailability.

FIG. 18 illustrates an example operation 1800 for non-primary channel access based on deferred signal transmission on the primary channel according to embodiments of the present disclosure. The embodiment of the example operation 1800 for non-primary channel access based on deferred signal transmission on the primary channel shown in FIG. 18 is for illustration only. Other embodiments of the example operation 1800 for non-primary channel access based on deferred signal transmission on the primary channel could be used without departing from the scope of this disclosure.

As illustrated in FIG. 18, the AP and the STA can jump to the non-primary channel and make the transmission based on deferred signal transmission on the primary channel. For example, other STAs may defer channel access during the transmission.

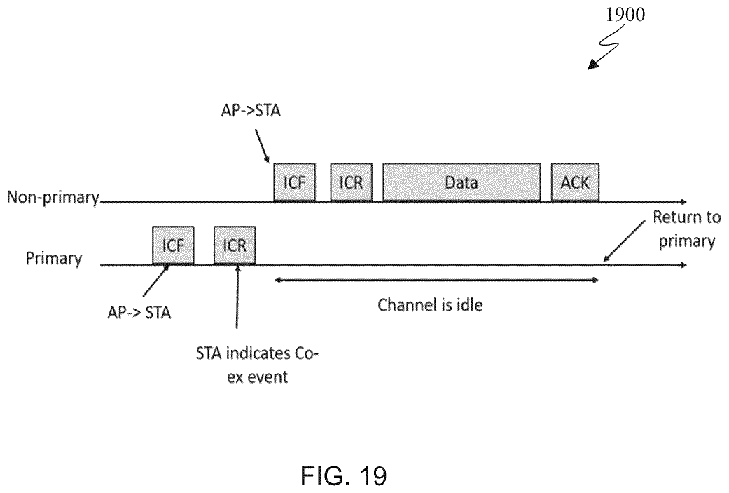

FIG. 19 illustrates an example operation 1900 for non-primary channel access by leaving the primary channel idle according to embodiments of the present disclosure. The embodiment of the example operation 1900 for non-primary channel access by leaving the primary channel idle shown in FIG. 19 is for illustration only. Other embodiments of the example operation 1900 for non-primary channel access by leaving the primary channel idle could be used without departing from the scope of this disclosure.

As illustrated in FIG. 19, the AP and the STA can jump to the non-primary channel and make the transmission based on the primary channel being idle.

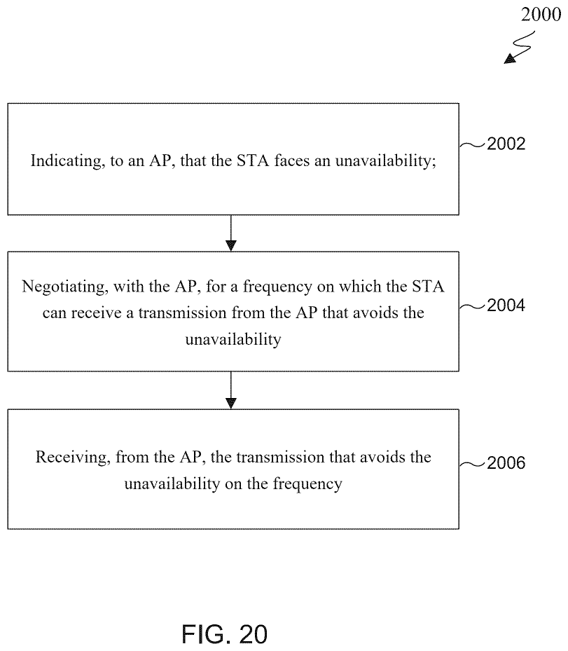

FIG. 20 illustrates an example method 2000 performed by a STA in a wireless communication system according to embodiments of the present disclosure. The method 2000 of FIG. 20 can be performed by any of the APs 111-114 of FIG. 1, such as the STA 111 of FIG. 3. The method 2000 is for illustration only and other embodiments can be used without departing from the scope of the present disclosure.

As illustrated in FIG. 20, the method 2000 begins at step 2002, where the STA transmits an indication to an AP associated with the STA that the STA faces an unavailability. At step 2004, the STA negotiates, with the AP, for a frequency on which the STA can receive a transmission from the AP that avoids the unavailability. At step 2006, the STA transmits information to the AP on the frequency that avoids the unavailability.

In some embodiments, the STA receives, from the AP, an indication of one or more frequency blocks that can be used for a dynamic sub-band operation (DSO); and negotiates, with the AP, allocation of a frequency block of the one or more frequency blocks for receipt of the transmission from the AP that avoids the unavailability.

In some embodiments, the STA transmits a message to the AP that includes one or more of: information indicating frequency blocks of the STA that either face or do not face the unavailability; information indicating a start time of the unavailability; information indicating a duration of the unavailability; information indicating interference from the unavailability; and information indicating transmit parameters that can be used by the STA to transmit to the AP.

In some embodiments, the STA performs the DSO operation using the frequency block based on the negotiation for the frequency.

In some embodiments, a primary channel between the AP and the STA is expected to face the unavailability; and the STA is configured to negotiate for a secondary channel to which the AP and the STA can switch to perform transmission and avoid the unavailability.

In some embodiments, the STA is further configured to: receive, from the AP, information indicating the primary channel that is expected to face the unavailability; or receive from the AP, information indicating the secondary channel to which the AP and the STA can switch to perform transmission and avoid the unavailability.

In some embodiments, the STA is further configured to transmit a message to the AP that includes information indicating the secondary channel to which the AP and the STA can switch to perform transmission and avoid the unavailability; to receive the transmission from the AP that avoids the unavailability on the frequency; and to switch to the secondary channel and perform data exchange on the secondary channel.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a station (STA) associated with an access point (AP), the method comprising:
indicating, to the AP, that the STA faces an unavailability;
negotiating, with the AP, for a frequency on which the STA can receive a transmission from the AP that avoids the unavailability; and
receiving, from the AP, the transmission that avoids the unavailability on the frequency.

2. The method of claim 1, wherein negotiating for the frequency comprises:
receiving, from the AP, an indication of one or more frequency blocks that can be used for a dynamic sub-band operation (DSO); and
negotiating, with the AP, allocation of a frequency block of the one or more frequency blocks for receipt of the transmission from the AP that avoids the unavailability.

3. The method of claim 2, wherein negotiating for the frequency further comprises transmitting a message to the AP that includes one or more of:
information indicating frequency blocks of the STA that either face or do not face the unavailability;
information indicating a start time of the unavailability;
information indicating a duration of the unavailability;
information indicating interference from the unavailability; and
information indicating transmit parameters that can be used by the STA to transmit to the AP.

4. The method of claim 3, further comprising performing the DSO operation using the frequency block based on the negotiation for the frequency.

5. The method of claim 1, wherein:
a primary channel between the AP and the STA is expected to face the unavailability; and
negotiating for the frequency further comprises negotiating for a secondary channel to which the AP and the STA can switch to perform transmission and avoid the unavailability.

6. The method of claim 5, wherein negotiating for the frequency further comprises:
receiving, from the AP, information indicating the primary channel that is expected to face the unavailability; or receiving, from the AP, information indicating the secondary channel to which the AP and the STA can switch to perform transmission and avoid the unavailability.

7. The method of claim 6, wherein:
negotiating for the frequency further comprises transmitting a message to the AP that includes information indicating the secondary channel to which the AP and the STA can switch to perform transmission and avoid the unavailability; and
receiving the transmission from the AP that avoids the unavailability on the frequency comprises switching to the secondary channel and performing data exchange on the secondary channel.

8. An access point (AP) comprising:
a transceiver; and
a processor operably coupled with the transceiver, the processor configured to:
receive, via the transceiver, an indication from a station (STA) associated with the AP that the STA faces an unavailability; and
negotiate, with the STA, for a frequency on which the STA can receive a transmission from the AP that avoids the unavailability,
wherein the transceiver is configured to transmit information to the STA on the frequency that avoids the unavailability.

9. The AP of claim 8, wherein to negotiate for the frequency, the processor is further configured to:
transmit via the transceiver, to the STA, an indication of one or more frequency blocks that can be used for a dynamic sub-band operation (DSO); and
negotiate, with the STA, allocation of a frequency block of the one or more frequency blocks for transmission of the information to the STA that avoids the unavailability.

10. The AP of claim 9, wherein to negotiate for the frequency, the processor is further configured to:
receive, via the transceiver, a message from the STA that includes one or more of:
information indicating frequency blocks of the STA that either face or do not face the unavailability;
information indicating a start time of the unavailability;
information indicating a duration of the unavailability;
information indicating interference from the unavailability; and
information indicating transmit parameters that can be used by the STA to transmit to the AP.

11. The AP of claim 10, wherein the processor is further configured to perform the DSO operation using the frequency block based on the negotiation for the frequency.

12. The AP of claim 8, wherein:
a primary channel between the AP and the STA is expected to face the unavailability; and
to negotiate for the frequency, the processor is further configured to negotiate for a secondary channel to which the AP and the STA can switch to perform transmission and avoid the unavailability.

13. The AP according to claim 12, wherein to negotiate for the frequency, the processor is further configured to:
transmit via the transceiver, to the STA, information indicating the primary channel that is expected to face the unavailability; or
transmit via the transceiver, to the STA, information indicating the secondary channel to which the AP and the STA can switch to perform transmission and avoid the unavailability.

14. A station (STA), comprising:
a transceiver; and
a processor operably coupled with the transceiver, the processor configured to:
transmit, via the transceiver, an indication to an access point (AP) associated with the STA that the STA faces an unavailability;
negotiate, with the AP, for a frequency on which the STA can receive a transmission from the AP that avoids the unavailability; and
transmit, via the transceiver, information to the AP on the frequency that avoids the unavailability.

15. The STA of claim 14, wherein to negotiate for the frequency, the processor is further configured to:
receive via the transceiver, from the AP, an indication of one or more frequency blocks that can be used for a dynamic sub-band operation (DSO); and
negotiate, with the AP, allocation of a frequency block of the one or more frequency blocks for receipt of the transmission from the AP that avoids the unavailability.

16. The STA of claim 15, wherein to negotiate for the frequency, the processor is further configured to:
transmit via the transceiver, a message to the AP that includes one or more of:
information indicating frequency blocks of the STA that either face or do not face the unavailability;
information indicating a start time of the unavailability;
information indicating a duration of the unavailability;
information indicating interference from the unavailability; and
information indicating transmit parameters that can be used by the STA to transmit to the AP.

17. The STA of claim 16, wherein the processor is further configured to perform the DSO operation using the frequency block based on the negotiation for the frequency.

18. The STA of claim 14, wherein:
a primary channel between the AP and the STA is expected to face the unavailability; and
to negotiate for the frequency, the processor is further configured to negotiate for a secondary channel to which the AP and the STA can switch to perform transmission and avoid the unavailability.

19. The STA of claim 18, wherein to negotiate for the frequency, the processor is further configured to:
receive via the transceiver, from the AP, information indicating the primary channel that is expected to face the unavailability; or
receive via the transceiver, from the AP, information indicating the secondary channel to which the AP and the STA can switch to perform transmission and avoid the unavailability.

20. The STA of claim 19, wherein:
to negotiate for the frequency, the processor is further configured to transmit, via the transceiver, a message to the AP that includes information indicating the secondary channel to which the AP and the STA can switch to perform transmission and avoid the unavailability; and
to receive the transmission from the AP that avoids the unavailability on the frequency, the processor is further configured to switch to the secondary channel and perform data exchange on the secondary channel.
